(19) United States
(12) Patent Application Publication
(10) Pub. No.: US 2015/0075761 A1
(43) Pub. Date: Mar. 19, 2015

(54) HEAT SINK ATTACHMENT TO TUBE

(71) Applicant: Ingersoll-Rand Company, Davidson, NC (US)

(72) Inventor: Stephen Stewart Hancock, Flint, TX (US)

(21) Appl. No.: 14/477,170

(22) Filed: Sep. 4, 2014

Related U.S. Application Data
(60) Provisional application No. 61/873,744, filed on Sep. 4, 2013.

(51) Int. Cl. F28F 1/12; B23P 15/26

(52) U.S. Cl. CPC F28F 1/12; B23P 15/26
USPC 165/181; 165/185; 29/890.045

(57) ABSTRACT

An exemplary heat sink includes a tube having a tube radius and first and second heat sink portions. Each heat sink portion includes an arcuate channel having a channel radius and a channel depth. Each channel radius is greater than the tube radius, and the sum of the channel depths is less than twice the tube radius. The heat sink is assembled by positioning the tube between the first and second heat sink portions, and urging the first and second heat sink portions toward one another, thereby deforming the tube.

### CROSS REFERENCE TO RELATED APPLICATIONS

The present application claims the benefit of U.S. Provisional Patent Application 61/873,744 filed Sep. 4, 2013, the contents of which are incorporated herein by reference in their entirety.

### TECHNICAL FIELD

The present invention generally relates to connections between a tube and a housing, and more particularly, but not exclusively, to connections between a tube and a heat sink.

### BACKGROUND

Present approaches to connecting coolant tubes to heat sinks suffer from a variety of drawbacks, limitations, disadvantages and problems including, among others, those arising from varying dimensions due to manufacturing tolerances. Generally speaking, there are three criteria to be addressed in the joining of a tube with a heat sink. The first includes maximizing heat transfer between the tube and the heat sink. This requires maximizing contact pressure and the area of contact between the tube and the heat sink. The second includes the ability to accommodate tubes and heat sinks with varying sizes according to the manufacturing tolerances of each. The third includes the ability to separate the tube from the heat sink for service or repair in some applications.

Certain conventional systems have attempted to address these concerns by processes such as swaging and brazing. For example, the tube may be press-fit into the heat sink, such as by expanding the tube to match the internal radius of the heat sink. Such conventional processes have drawbacks and limitations.

Other conventional systems employ a matching-radius clamp. Such systems can address the first concern when the tube closely conforms to the nominal design specifications. One such system is illustrated in FIG. 1, wherein the conventional clamp 10 is formed of two clamp portions 12, and the tube is a nominal-radius tube 22 having a nominal outer radius rₙₒₘ. Each of the clamp portions 12 includes an arcuate channel 14 having a radius r₁₄ corresponding to the nominal outer radius rₙₒₘ.

With reference to FIG. 2, an assembled heat sink 2 is formed when the nominal-radius tube 22 is positioned in the conventional clamp 10. In the heat sink 2, the surfaces of the tube 22 and clamp portions 12 are in close contact, thereby providing the desired heat transfer properties between the tube 22 and the clamp 10. Due to manufacturing tolerances, however, the tube radius and/or the clamp radius often varies from the nominal radius rₙₒₘ.

With reference to FIG. 3, an assembled heat sink 3 includes the conventional clamp 10 and a minimum-radius tube 23. The minimum-radius tube 23 has the minimum tube radius permitted by tolerances rₘᵢₙ. In the assembled heat sink 3, there are areas where the tube 23 and the clamp portions 12 are not in contact, which reduces heat transfer between the tube 23 and the clamp 10.

With reference to FIG. 4, an assembled heat sink 4 includes the conventional clamp 10 and a maximum-radius tube 24. The maximum-radius tube 24 has the maximum tube radius permitted by tolerances rₘₐₓ. In the assembled heat sink 4, the channel 14 cannot accommodate the tube 24. This results in gaps, both between the clamp portions 12, as well as between the tube 24 and the clamp portions 12. Each of these gaps reduce heat transfer between the tube 24 and the clamp 10.

In light of the reduced heat transfer resulting from varying radii, tight tolerances must be maintained during manufacture of the tube and the clamp, increasing cost. Even when tight tolerances are maintained, however, variation within the tolerances leads to reduced heat transfer coefficients. Accordingly, there is a need for the unique and inventive apparatuses, systems and methods disclosed herein.

### SUMMARY

An exemplary heat sink includes a tube having a tube radius and first and second heat sink portions. Each heat sink portion includes an arcuate channel having a channel radius and a channel depth. Each channel radius is greater than to the tube radius, and the sum of the channel depths is less than twice the tube radius. The heat sink is assembled by positioning the tube between the first and second heat sink portions, and urging the first and second heat sink portions toward one another, thereby deforming the tube. Further embodiments, forms, features, aspects, benefits, and advantages of the present application shall become apparent from the description and figures provided herewith.

### BRIEF DESCRIPTION OF THE FIGURES

FIG. 1 is a cross-sectional illustration of a conventional clamp and nominal-radius tube prior to assembly.

FIG. 2 is a cross-sectional illustration of an assembled heat sink including the conventional clamp and nominal-radius tube.

FIG. 3 is a cross-sectional illustration of an assembled heat sink including the conventional clamp and a minimum-radius tube.

FIG. 4 is a cross-sectional illustration of an assembled heat sink including the conventional clamp and a maximum-radius tube.

FIG. 5 is a cross-sectional illustration of an clamp according to one embodiment of the invention and a nominal-radius tube prior to assembly.

FIG. 6 is a cross-sectional illustration of an assembled heat sink including an inventive clamp and a nominal-radius tube.

FIG. 7 is a cross-sectional illustration of an assembled heat sink including an inventive clamp and a minimum-radius tube.

FIG. 8 is a cross-sectional illustration of an assembled heat sink including an inventive clamp and a maximum-radius tube.

FIG. 9 is an exploded perspective view of a heat sink clamp and tube according to one embodiment of the present disclosure.

FIG. 10 is a perspective view of a heat sink system according to another embodiment of the present disclosure.

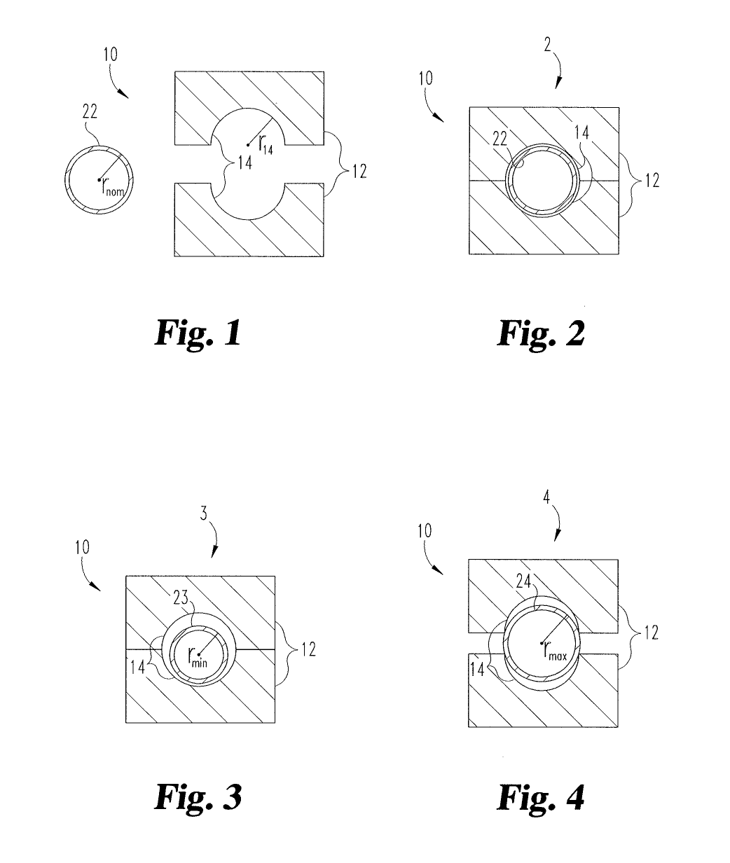

### DETAILED DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

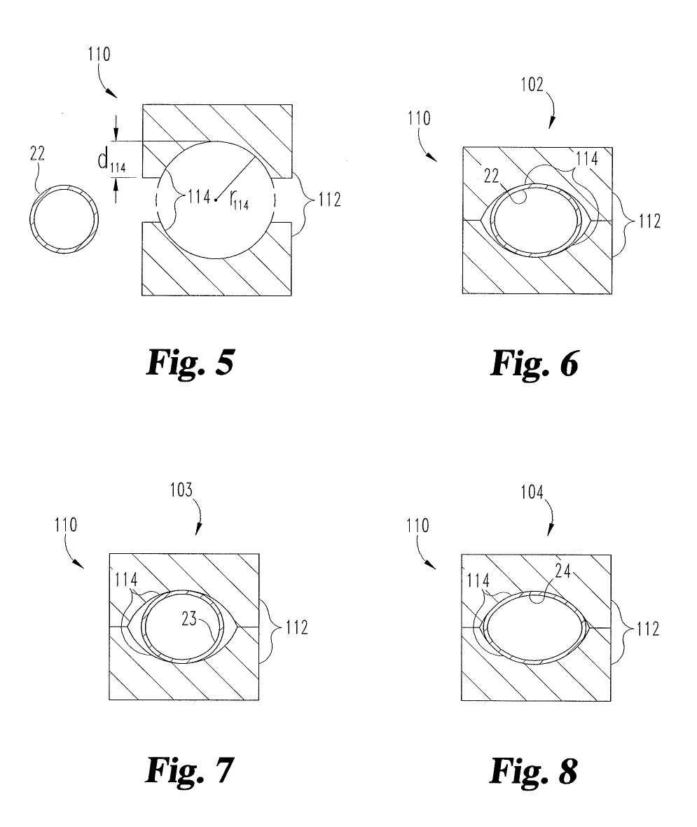

FIGS. 5-8 illustrate systems including an exemplary clamp 110 according to an embodiment of the present invention. FIGS. 6, 7, and 8 illustrate heat sinks 102, 103, and 104 including the clamp 110 and the aforementioned nominal-radius tube 22, minimum-radius tube 23, and maximum-radius tube 24, respectively. In each of the illustrated heat sinks, the tube comprises a portion of a heat transfer circuit through which a heat transfer medium—such as a coolant or refrigerant—flows. For example, the heat transfer circuit may be a coolant circuit or a vapor compression circuit. Alternatively the heat transfer medium may be a heated fluid to increase the temperature of a component in thermal communication with the heat transfer circuit.

The illustrated clamp 110 is thermally coupled to a device to or from which heat transfer is desired. The device may be, for example, an evaporator, a condenser, or a heat generating device such as a microprocessor, variable frequency drive (VFD), or inverter. When the heat transfer medium flows through the tube, thermal energy is transferred between the heat transfer medium and the device through the clamp 110. The clamp 110 may be formed of any suitable heat-conducting material, such as, by way of non-limiting example, aluminum or copper. Furthermore, the heat sink may include additional features to transfer heat energy to or from the heat transfer medium, such as fins, baffles, and the like.

With reference to FIG. 5, the illustrative clamp 110 includes clamp portions 112, each of which includes an arcuate channel 114. For reasons described below, each channel 114 comprises a channel radius r₁₁₄ greater than to the maximum tube radius rₘₐₓ, a channel depth d₁₁₄ less than the minimum tube radius rₘᵢₙ, and a perimeter greater than or equal to half the circumference of the maximum-diameter tube 24. In the illustrated embodiment, the tube 22 is a tube of circular cross-section, although it is also contemplated that a tube may be of a different geometry. For example, a tube may be elliptical in cross-section, in which case the channel depth d₁₁₄ would be less than the minimum minor radius permitted by tolerances.

FIG. 6 illustrates an assembled heat sink 102 including the clamp 110 and the nominal-radius tube 22. During manufacture, the tube 22 is placed between the clamp portions 112, and the clamp portions 112 are urged toward one another, deforming the tube 22. The deformation of the tube 22 urges sections of the outer surface of the tube 22 into intimate contact with sections of the inner surface of the channels 114. Here, one can see the intimate contact between the tube 22 and clamp 110 along the full periphery of the tube 22 except for a small area where the clamp portions 112 meet.

FIG. 7 illustrates an assembled heat sink 103 including the clamp 110 and the minimum-radius tube 23. The heat sink 103 is assembled in the same manner as the heat sink 102. Because the channel depth d₁₁₄ of each channel 114 is less than the minimum tube radius rₘᵢₙ, urging the clamp portions toward one another will cause the tube therebetween to deform, even when the tube is a minimum-radius tube 23. This provides for increased contact pressure and area between the tube 23 and clamp 110 (and therefore increased heat transfer coefficient) as compared to the heat sink 3 using the conventional clamp 10. In fact, good contact is maintained over most of the perimeter of the tube 23.

Should the tube have an elliptical cross-section, the sum of the channel depths d₁₁₄ is less than twice the minimum minor radius permitted by tolerances, and the elliptical tube will undergo similar deformation as the illustrated minimum-radius tube 23. The tube may alternatively be of another configuration, in which case the sum of the channel depths d₁₁₄ would be less than the minimum height (i.e. the dimension in the direction along which the compressive force is applied) permitted by tolerances. Thus, the present clamp 110 may be used with tubes having non-circular, non-elliptical cross-sections.

With reference to FIG. 8, an assembled heat sink 104 including the clamp 110 and the maximum-radius tube 24 is illustrated. The heat sink 104 is assembled in the same manner as the heat sink 102. Because the channel radius r₁₁₄ is greater than to the maximum tube radius rₘₐₓ, the maximum-radius tube 24 has room to deform in the horizontal direction when compressed in the vertical direction. Again, good contact is maintained over nearly the full perimeter of the tube 24. Furthermore, because the sum of the perimeters of the channels 114 is greater than or equal to the circumference of the maximum-radius tube 24, the tube 24 is able to deform to a shape corresponding to that of the channels 114 without buckling or warping, which would lead to a decreased contact area (and therefore a decreased heat transfer coefficient).

As is evident from the foregoing drawings and description, the clamp 110 provides for increased contact area between the clamp and the tube, allowing for looser tolerances (decreased costs) and improved contact pressure and area (increased efficiency). Furthermore, because the cavity radius r₁₁₄ is greater than the tube radius in all cases, the clamp 110 can be easily separated from the tube should service or replacement be desired.

In the illustrated embodiment, the clamp 110 and tube are configured for conducting heat between the tube and an external device. It is also contemplated that the clamp 110 may be used in other applications in which a tube or other approximately cylindrical body needs to be attached intimately to a plate. The increased contact area between the tube and the plate can be used to improve not only thermal transfer properties, but additionally or alternatively electrical transfer properties. For example, the clamp 110 may be used in an electrical circuit to electrically ground the tube.

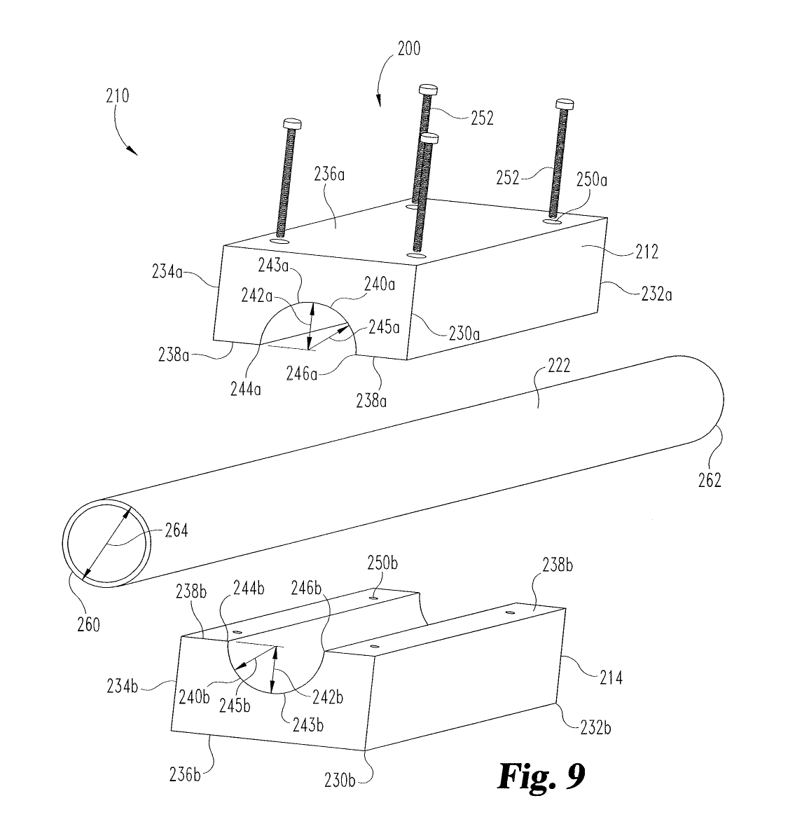

Referring now to FIG. 9 another embodiment of a heat sink system 200 is illustrated. A heat sink clamp 210 can include a first clamshell portion 212 and a second clamshell portion 214 operable for engaging in thermal communication with a tube 222. In one form the first clamshell portion 212 and the second clamshell portion 214 are substantially similar or identical in dimension and shape. In other forms, the first and second clamshell portions 212, 214 can have differing dimensions and shapes in one or more locations or areas. The feature callouts for the first and second clamshell portions 212, 214 are labeled with identical numbers, but with an “a” or a “b” suffix to differentiate the clamshell portions. The first clamshell portion 212 will be described with an “a” suffix and it should be understood that that an identical number with a “b” suffix is illustrated with respect to the second clamshell portion 214 and will not be specifically described separately herein. It should also be understood that some embodiments of the present disclosure may include variations in shape and dimensions between the first clamshell portion 212 and the second clamshell portion 214 and that while identical numbers refer to the same feature on each of the clamshell portions 212, 214, the numbers need not refer to an equivalent size or shape of the feature.

The first clamshell portion 212 can extend between a first end 230a and a second end 232a. A side wall height 234a is defined and bounded by a top wall 236a and a bottom wall 238a. An arcuate channel 240a is formed through the bottom wall 238a. The arcuate channel 240a is defined by a channel depth 242a extending from the bottom wall 238a to a peak of an arcuate channel wall 243a formed with a defined radius 245a. Opposing end points 244a, 246a of the arcuate channel 240a define a channel width of the arcuate channel 240a therebetween. A channel perimeter of the arcuate channel wall 243a is defined as a distance measured along the arc of the arcuate channel 240a from one channel end 244a to the other channel end 246a. The second clamshell portion 214 includes identical parameters, however as explained above the magnitude of the dimensions may differ between the first and second clamshell portions 212, 214 in some embodiments. A combined channel perimeter is defined as the total distance of the combined perimeter of the arcuate channel walls 243a and 243b.

The tube 222 having a diameter 264 can extend between first and second ends 260 and 262 to define a length thereof. The tube 222 can be positioned within the arcuate channels 240a and 240b of the clamshell portions 212, 214, respectively. In one form the clamshell portions 212, 214 extend along the entire length of the tube 222 and in other forms the clamshell portions 212, 214 extend only along a portion of the entire length of the tube 222. In some embodiments, a plurality of discreet tubes 222 can be positioned within the clamshell portions 212, 214. In some embodiments, the clamshell portions 212, 214 can be in thermal communication with the tube 222 along their entire length between the first end 230a and the second end 232a thereof. In other embodiments, thermal communication may occur along smaller or intermittent portions between the first and second ends 230a, 232a of the clamshell portions 212, 214.

One or more threaded fasteners 252 can be positioned through an aperture 250a of the first clamshell portion 212 and extend into threaded receivers 250b formed in the in the second clamshell portion 214. Alternatively, the threaded fasteners 252 may extend through apertures in clamshell portion 214 and engage with a threaded nut (not shown) external to the clamshell portion 214. Other forms of clamping or holding the opposing clamshell portions 212, 214 together include, but are not limited to mechanical clip, weld, braze, or glue or external housing means.

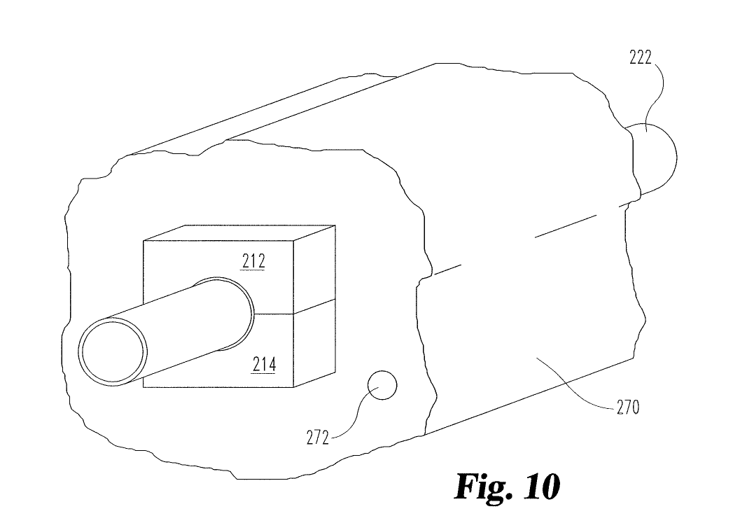

Referring now to FIG. 10 another embodiment of a heat sink system according to the present disclosure is illustrated. The clamshell portions 212, 214 can be positioned within a housing 270 in certain embodiments. In this manner heat can be transferred to or from the housing via the heat sink clamshell portions 212, 214. The housing 270 can include one or more apertures or passageways 272 to permit heat transfer fluid such as a relative cool fluid or a relatively warm fluid to traverse throughout portions thereof. Depending on the application, the housing can be formed from a heat conductive material, an insulating material or a combination of both as would be known to those skilled in the art. In one form the housing 270 can hold the clamshell portions 212, 214 together without use of additional mechanical fastener combinations after being clamped over the tube 222.

While descriptors referring to top, bottom, side, lower or upper or other similar descriptors may be used to define certain feature herein, it should be understood that these descriptors are used to define relative positions with respect to certain features of the system and not absolute positioning. For example the first and second clamshell portions 212, 214 can be located at a top and bottom of a tube or at either side of a tube. Furthermore, as another example, the top wall 236a of the first clamshell portion 212 and the top wall 236b of the second clamshell portion 214 will face in opposite directions when assembled together in an operable configuration and neither top wall 236a or 236b may be in a “top” position as may be understood in an absolute sense.

In operation the heat sink system defined herein provides means for transmitting heat to and from a tube regardless of whether the actual diameter is different from a nominal size due to variations in manufacturing tolerances. A fluid can be transported through the tube to define a heat transfer medium in some embodiments. The fluid can be a cooling fluid or a heating fluid depending on the desired application of the heat sink system. A heat sink clamp can be formed according to the teachings herein and can be used to clamp over the tube. The design of the heat sink clamp is such that any tube falling within a range of minimum and maximum tolerance bands will be deformed as the opposing clamp portions are drawn together. The clamping or tightening force can be accomplished through tightening of a threaded fastener extending between the opposing heat sink portions or other techniques as would be known to those skilled in the art. The resulting deformed tube provides a maximum contact area for any sized tube falling within a diameter tolerance range and thus maximizes heat transfer between the tube and the heat sink clamp, regardless of the tube size. Heat can be transferred between the tube and heat sink clamp through conduction heat transfer means. Subsequently, heat can be transferred directly to ambient surroundings in some embodiments or to another housing positioned externally around the heat sink clamp in other embodiments.

In one aspect the present disclosure includes a system comprising: a tube having a tube radius and a circumference, the tube radius being defined by a manufacturing tolerance ranging between a minimum tube radius and a maximum tube radius and the tube circumference being defined by a manufacturing tolerance ranging between a minimum tube circumference and a maximum tube circumference; a heat sink having first clamshell and second clamshell portions, each clam shell portion having an arcuate channel defined by a channel radius, a channel width and a channel depth; wherein the channel radius is greater than the maximum tube radius, the channel depth is less than the minimum tube radius, and the channel width is greater than the maximum tube diameter.

In refining aspects the heat sink extends along an entire length of the tube; the heat sink is configured to deform the tube when the first and second clamshell portions are clamped together; the tube is deformed from a substantially circular cross section to an ovalized cross section; the heat sink is in contact with the tube along the arcuate channels of the first and second clamshell portions; heat is transferred between the tube and the heat sink via conduction through contacting portions of the tube and arcuate channels; the heat sink extends across a plurality of discrete tubes; further comprising at least one of threaded fasteners, mechanical clip, weld, braze, or glue for holding the first and second clamshells in a clamped orientation; and further comprising a housing positioned in thermal communication about the heat sink.

In another aspect the present disclosure includes a heat sink for a tube having a diameter sized between a minimum diameter and a maximum diameter, the heat sink comprising: a first clamshell portion having a first arcuate channel defined by a channel radius, a channel width, a channel perimeter and a channel depth; a second clamshell portion having a second arcuate channel defined by a channel radius, a channel width, a channel perimeter and a channel depth; and wherein each of the first and second arcuate channels have a channel radius that is greater than a maximum tube radius, a channel depth that is less than a minimum tube radius, and a combined channel perimeter that is greater than or equal to a circumference of a maximum diameter tube.

In refining aspects, the clamshell portions are configured to deform a portion of the tube when clamped together; the heat sink is engaged with the tube to transfer heat to and from fluid within the tube; the heat sink is configured to extend along an entire length of the tube; the heat sink is configured to extend across a plurality of tubes; the first and second clamshells are not identical in shape or dimension; further comprising fastening means for holding the first and second clamshells in an engaged position with a tube after the tube has been deformed within the arcuate channels; and the clamshell portions are formed from one or more materials having a defined heat transfer capability.

Another aspect includes a method for placing a heat sink in thermal communication with a tube having manufacturing tolerances defining a minimum tube diameter and a maximum tube diameter, the method comprising: forming a heat sink clamp having opposing portions, each of the opposing portions having an arcuate channel defined by a channel radius, a channel width, a channel perimeter and a channel depth; wherein each of the first and second channels have a channel radius that is greater than the maximum tube radius, a channel depth that is less than the minimum tube radius, and a combined channel perimeter that is greater than or equal to a circumference of a maximum diameter tube; inserting a tube within an arcuate channel of one of the opposing portions; placing the other of the opposing portions over the tube; pressing the opposing portions together; and deforming a portion of the tube engaged with the arcuate channels of the opposing portions.

In refining aspects the method further includes holding the opposing portions of the heat sink in position after the deforming; wherein the holding includes at least one of threaded fastener, mechanical clip, weld, braze, glue and a housing positioned externally around the opposing portions; and transferring heat between the heat sink and the tube.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A system comprising:
a tube having a tube radius and a circumference, the tube radius being defined by a manufacturing tolerance ranging between a minimum tube radius and a maximum tube radius;
a heat sink having first clamshell and second clamshell portions, each clam shell portion having an arcuate channel defined by a channel radius, a channel width and a channel depth;
wherein the channel radius is greater than the maximum tube radius, the channel depth is less than the minimum tube radius, and the channel width is greater than the maximum tube diameter for each of the first and second clamshell portions.

2. The system of claim 1, wherein the heat sink extends along an entire length of the tube.

3. The system of claim 1, wherein the heat sink is configured to deform the tube when the first and second clamshell portions are clamped together.

4. The system of claim 3, wherein the tube is deformed from a substantially circular cross section to an ovalized cross section.

5. The system of claim 1, wherein the heat sink is in contact with the tube along the arcuate channels of the first and second clamshell portions.

6. The system of claim 5, wherein heat is transferred between the tube and the heat sink via conduction through contacting portions of the tube and arcuate channels.

7. The system of claim 1, wherein the heat sink extends across a plurality of discrete tubes.

8. The system of claim 1, further comprising at least one of threaded fasteners, mechanical clip, weld, braze, or glue for holding the first and second clamshells in a clamped orientation.

9. The system of claim 1, further comprising a housing positioned in thermal communication about the heat sink.

10. A heat sink for a tube having a diameter sized between a minimum diameter and a maximum diameter, the heat sink comprising:
a first clamshell portion having a first arcuate channel defined by a channel radius, a channel width, a channel perimeter and a channel depth;
a second clamshell portion having a second arcuate channel defined by a channel radius, a channel width, a channel perimeter and a channel depth;
wherein each of the first and second arcuate channels have a channel radius that is greater than a maximum tube radius, a channel depth that is less than a minimum tube radius, and a combined channel perimeter that is greater than or equal to a circumference of a maximum diameter tube.

11. The heat sink of claim 10, wherein the clamshell portions are configured to deform a portion of the tube when clamped together.

12. The heat sink of claim 10, wherein the heat sink is engaged with the tube to transfer heat to and from fluid within the tube.

13. The heat sink of claim 10, wherein the heat sink is configured to extend along an entire length of the tube.

14. The heat sink of claim 10, wherein the heat sink is configured to extend across a plurality of tubes.

15. The heat sink of claim 10, wherein the first and second clamshells are not identical in shape or dimension.

16. The heat sink of claim 10, further comprising fastening means for holding the first and second clamshells in an engaged position with a tube after the tube has been deformed within the arcuate channels.

17. The heat sink of claim 10, wherein the clamshell portions are formed from one or more materials having a defined heat transfer capability.

18. A method for placing a heat sink in thermal communication with a tube having manufacturing tolerances defining a minimum tube diameter and a maximum tube diameter, the method comprising:
forming a heat sink clamp having opposing portions, each of the opposing portions having an arcuate channel defined by a channel radius, a channel width, a channel perimeter and a channel depth; wherein each of the first and second channels have a channel radius that is greater than the maximum tube radius, a channel depth for each of the opposing portions that is less than the minimum tube radius, and a combined channel perimeter that is greater than or equal to a circumference of a maximum diameter tube;
inserting a tube within an arcuate channel of one of the opposing portions;
placing the other of the opposing portions over the tube;
pressing the opposing portions together; and
deforming a portion of the tube engaged with the arcuate channels of the opposing portions.

19. The method of claim 18, further comprising holding the opposing portions of the heat sink in position after the deforming; wherein the holding includes at least one of a threaded fastener, mechanical clip, weld, braze, glue and a housing positioned externally around the opposing portions.

20. The method of claim 18, further comprising transferring heat between the heat sink and the tube.
